(19) United States
(12) Patent Application Publication
(10) Pub. No.: US 2019/0327989 A1
(43) Pub. Date: Oct. 31, 2019

(54) ENERGY EFFICIENT SYSTEM AND METHOD FOR PASTEURIZING MILK FOR CULTURED DAIRY PRODUCTS

(71) Applicant: Richard W. Ford, East Amherst, NY (US)

(72) Inventor: Richard W. Ford, East Amherst, NY (US)

(21) Appl. No.: 15/963,452

(22) Filed: Apr. 26, 2018

(51) Int. Cl. A23C 3/033; A23C 9/12

(52) U.S. Cl. CPC A23C 3/033; A23C 9/122

(57) ABSTRACT

An energy efficient system and method for pasteurizing milk for cultured dairy products reduces the energy required to pasteurize milk for cultured dairy products. A preheating module preheats raw milk. A waste heat control system harnesses medium temperature waste heat from waste heat source modules to release heat to the preheating module for preheating the raw milk. The preheating reduces the amount of heat required to heat the milk to higher pasteurization temperatures in a subsequent regeneration module and heating module. The regeneration module enables between outgoing high temperature pasteurized milk and incoming preheated milk heat, allowing the pasteurized milk to cool down to a culture temperature of about 108° Fahrenheit for culturing dairy products. The preheating temperature control and the controlled transfer of heat eliminate the need for reheating the cooled pasteurized milk. A homogenizer, cream separator, and degasser can integrate into the system for purifying the milk.

### FIELD OF THE INVENTION

The present invention relates generally to an energy efficient system and method for pasteurizing milk for cultured dairy products. More so, the present invention relates to a system and method that reduces the energy required to pasteurize milk for cultured dairy product through use of a preheating module that preheats raw milk with heat from a warm water supply and waste heat sources; whereby a waste heat control system regulates the release of the waste heat to harness medium temperature waste heat from multiple waste heat source modules to preheat raw milk; whereby the process of preheating the raw milk reduces the amount of heat required to heat the milk to higher pasteurization temperatures in a subsequent regeneration module and heating module; whereby the regeneration module provides heat transfer that further heats the preheated milk, and causes the high temperature pasteurized milk to cool down to a culture temperature of about 86° to 113° Fahrenheit, which is an appropriate temperature for culturing dairy products, and also higher than standard pasteurized temperatures; whereby the culture bacteria for converting milk to cultured dairy products grows optimally in a range of 86° to 113° Fahrenheit depending on the product being made and the culture used; and whereby a homogenizing module may be used for homogenizing the milk, in addition to the stated pasteurization.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Generally, heat treatment of foodstuffs for human consumption includes methods, such as cooking, pasteurization, and sterilization. Pasteurization has been used to purify drinking milk and cultured dairy products. Dairy farmers and other producers of foodstuffs such as milk are often required to produce, transport, and market dairy products for processing including pasteurization and packaging.

Typically, pasteurization involves a process of heating milk up and then quickly cooling it down to eliminate certain bacteria. Often, the milk is heated up to at least 161.6° Fahrenheit (72° Celsius) for 15 seconds, which is known as High-temperature Short-Time (HTST) pasteurization, or flash pasteurization. This method maintains milk fresh for two to three weeks. Milk treated with pasteurization or HTST is labeled as “pasteurized”. This minimal heat-treatment limits the amount of heat denaturation of milk protein that occurs during pasteurization. Higher pasteurization temperatures and/or longer pasteurization times increase the heat denaturation of milk proteins, which is desirable for some cultured products.

In many cases, raw milk must first be heated for a certain treatment and then cooled. For example, chilled milk is heated from perhaps 4° C. to a pasteurization temperature of 72° C., held at that temperature for 15 seconds and then chilled to 4° C. again. The heat of the pasteurized milk is utilized to warm the cold milk. The incoming cold milk is pre-heated by the outgoing hot milk, which is simultaneously pre-cooled. This saves heating and refrigeration energy. The process takes place in a heat exchanger and is called regenerative heat exchange or, more commonly, heat recovery. Typically, as much as 94-95% of the heat content of the pasteurized milk can be recycled.

Other proposals have involved pasteurizing systems and methods for milk, and especially cultured dairy products. The problem with these pasteurizing systems and methods is that they consume large quantities of energy to heat the milk. Also, the specific culture temperature for culturing the pasteurized milk is not achieved without use of a reheating means after the milk leaves the regenerator. Even though the above cited pasteurizing systems and methods meet some of the needs of the market, an energy efficient system and method for pasteurizing milk for cultured dairy products that reduces the amount of energy required to pasteurize milk for cultured dairy by passing the milk through a continuous flow process, or a batch process, that includes a preheating module that preheats raw milk, multiple waste heat source modules that release waste heat to the preheating module, a waste heat control system that regulates the waste heat, a regeneration module comprising a heat exchange mechanism that transfers heat between outgoing high temperature pasteurized milk and incoming preheated milk, a homogenizing module, a heating module that heats the preheated milk to a high temperature pasteurized temperature, a holding tube, a booster pump, and a culture tank for culturing the cooled pasteurized milk into cultured dairy products, is still desired.

### SUMMARY

Illustrative embodiments of the disclosure are generally directed to an energy efficient system and method for pasteurizing milk for cultured dairy products. The system and method is configured to reduce the amount of energy required to pasteurize milk for cultured dairy by passing the milk through a continuous flow process, or a batch process, that includes: a preheating module that preheats raw milk, at least one waste heat source module that releases waste heat to the preheating module, a waste heat control system that regulates the waste heat, a regeneration module comprising a heat exchange mechanism that transfers heat between outgoing high temperature pasteurized milk and incoming preheated milk, a homogenizing module, a heating module that heats the preheated milk to a high temperature pasteurized temperature, a holding tube, a booster pump, and a culture tank for culturing the cooled pasteurized milk into cultured dairy products.

The system introduces raw milk into a balance tank. The raw milk enters the balance tank at about 38° Fahrenheit. The raw milk flows into the preheating module to preheat the raw milk. Multiple waste heat source modules release heat to the preheating module to preheat the raw milk. The waste heat is harnessed through a waste heat control system to reduce the amount of energy required to heat the milk. The raw milk flows out of the preheating module while heated up to a higher temperature that prevents the milk from over cooling in the regeneration module, discussed below.

Next, the preheated milk passes through the regeneration module. The regeneration module comprises a heat exchange system that is configured to allow the preheated milk and high temperature pasteurized milk to flow in opposite directions on opposite sides of a heat exchange surface. The preheated milk entering the regeneration module receives released heat from the high temperature pasteurized milk leaving the regeneration module. Consequently, the amount of heating required to heat the incoming preheated milk to high temperatures in a subsequent heating module is reduced, which conserves energy.

The heated milk next flows through a heating module that heats the milk up to a pasteurization temperature of about 188° Fahrenheit. The now extremely hot, pasteurized milk flows into a holding tube for a predetermined duration before passing through a booster pump that increases the pressure of the pasteurized milk. The booster pump forces the pasteurized milk through the heat exchange system in an opposite direction from the cooler preheated milk.

The high temperature pasteurized milk flowing out of the regeneration module transfers heat to the preheated milk entering the regeneration module. This causes the high temperature pasteurized milk to cool down to a culture temperature of about 86° Fahrenheit, which is higher than the standard pasteurized temperature, and also an appropriate temperature for culturing dairy products. This is because the culture bacteria used to convert milk to cultured dairy products grows best in higher temperatures, i.e. 86° Fahrenheit. The cooled pasteurized milk next flows into a culture tank for further culturing and storage. Further, a homogenizer, cream separator, and degasser can integrate into the system for homogenizing the milk.

In one aspect of the present invention, the system further comprises a homogenizing module receiving heated milk from the regeneration module.

In another aspect, the system further comprises a waste heat control system regulating waste heat from the multiple waste heat source modules.

In another aspect, the multiple waste heat source modules include at least one of the following: a refrigeration desuperheater, a boiler stack, product cooling, an air compressor cooling system, and a refrigeration condenser emitting exhaust gas and the like.

In another aspect, the system comprises an initial preheating module operable to preheat the raw milk with waste heat prior to entering the regeneration module.

In another aspect, the system comprises a water heater providing heat to the heating module.

In another aspect, the system comprises a cream separator, or a degasser, or both receiving heated milk from the regeneration module.

One objective of the present invention is to conserve energy while pasteurizing milk for cultured dairy products.

Another objective is to provide a milk pasteurization system, which conserves energy through preheating and use of waste heat.

Another objective is to provide a milk pasteurization system that produces savings of about $0.028/cwt. for milk made into the cultured dairy product, i.e., yogurt, relative to the prior art milk pasteurization system.

Another objective is to provide only the amount of cooling in the regeneration module that is needed to bring the temperature of the pasteurized milk down from the pasteurization temperature to the culture temperature.

Yet another objective is to kill unwanted bacteria in milk.

Yet another objective is to cause proteins in the milk to be denatured to facilitate the manufacture of cultured products.

Yet another objective is to eliminate the need for a reheating module, since the preheating module heats the raw milk prior to entering the regeneration module and the heating module.

Yet another objective is to enable heat treated milk to flow out of the regeneration module, and then subsequently flow into the culture tank at the desired culture temperature, rather than going to a reheating section prior to the culture tank.

Yet another objective is to enable inflow of raw milk into the preheating module, rather than at the regeneration module.

Yet another objective is to harness medium temperature waste heat in a preheating module rather than hot water from a water heater and an external fuel source in a reheating module.

Yet another objective is to provide a waste heat control system to adjust the amount of heat added at the preheating module.

Yet another objective is to provide an inexpensive to operate milk pasteurization system.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a schematic diagram of a prior art milk pasteurization system, in accordance with an embodiment of the present invention;

FIG. 2 illustrates a schematic diagram of an exemplary system for pasteurizing milk for cultured dairy products, in accordance with an embodiment of the present invention;

FIGS. 3A and 3B illustrate Tables referencing exemplary data points for operation of the system for pasteurizing milk for cultured dairy products, where FIG. 3A shows data for prior art milk pasteurization system, and FIG. 3B shows data for the system for pasteurizing milk for cultured dairy products, in accordance with an embodiment of the present invention;

FIGS. 4A-4C illustrate a flowchart and accompanying Tables for an exemplary process and resultant data for pasteurizing raw milk, where FIG. 4A is a flowchart showing the flow of milk through the various modules at different temperatures, being heated by the warm water supply and waste heat, so as to achieve the resultant pasteurized milk temperatures, FIG. 4B is the data for each step of the flowchart process, and FIG. 4C is an Economic Analysis Table from the process, in accordance with an embodiment of the present invention; and

FIGS. 5A and 5B illustrate flowcharts of an exemplary method for pasteurizing milk for cultured dairy products, in accordance with an embodiment of the present invention.

Like reference numerals refer to like parts throughout the various views of the drawings.

### DETAILED DESCRIPTION OF THE INVENTION

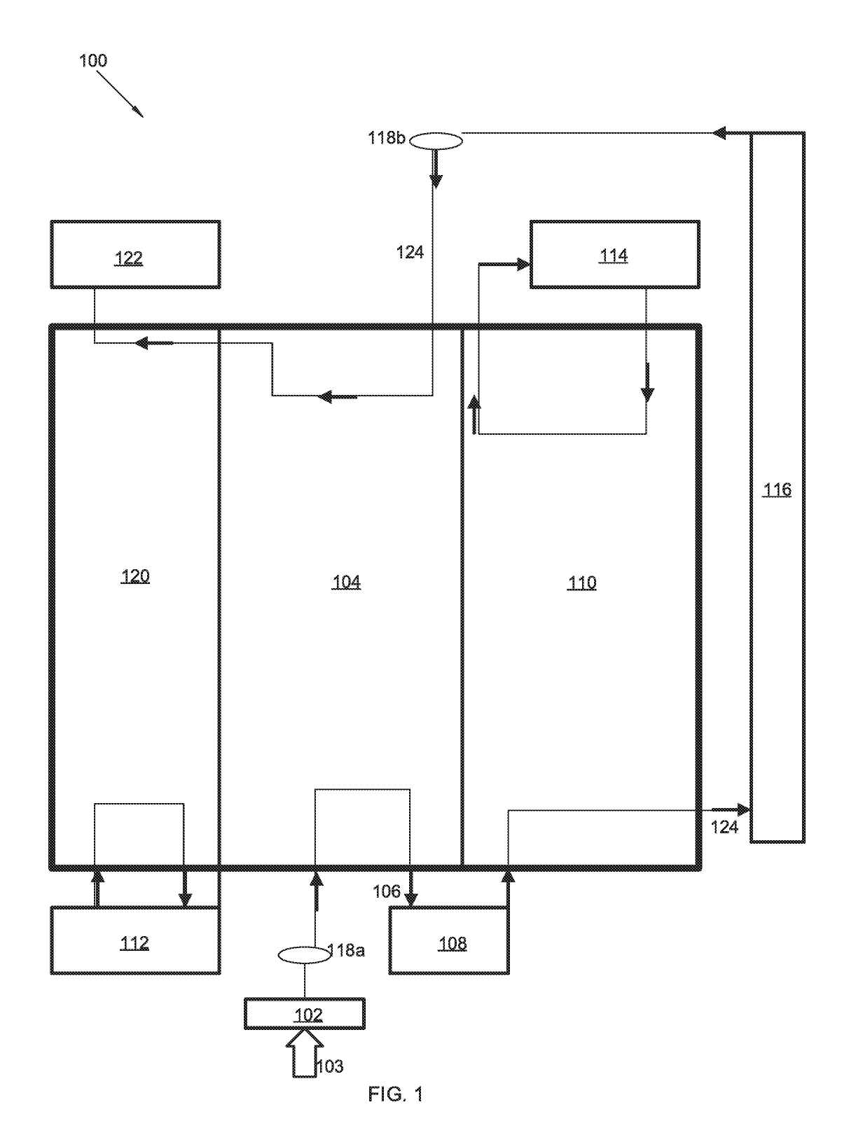

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

An energy efficient system 200 and method 500 for pasteurizing milk for cultured dairy products is referenced in FIGS. 1-5B. System 200 works to urge raw milk through a continuous flow pasteurization process, or a batch pasteurization process, that heats raw milk 202 up to a cultured temperature for production of cultured dairy products. The milk passes through a series of modules that sequentially heat, cool, homogenize, and transfer heat to raw milk 202, so as to achieve a culture temperature that is efficacious for culturing dairy products, such as yogurt, cheese, sour cream, and buttermilk. The modules work together to reduce the amount of energy required to pasteurize the milk.

This conservation of energy is accomplished by preheating the raw milk 202 with waste heat released from multiple waste heat sources 206 prior to heating the milk to the pasteurization temperature, and eliminating reheating of the cooled pasteurized milk 232 through control of preheating temperatures and heat transfer between high temperature pasteurized milk 226 and preheated milk 202. By preheating the raw milk 202 and eliminating reheating of the cooled pasteurized milk 232, the culture temperature for dairy products (86° Fahrenheit), which is higher than the pasteurized temperature (39.2° Fahrenheit) for drinking milk, can be reached efficiently. This allows the system 200 to achieve the objective of conserving energy while pasteurizing milk for cultured dairy products. Further, a homogenizing module 216, cream separator 218, and degasser 220 may integrate into system 200 for homogenizing the milk.

In one non-limiting embodiment, system 200 urges the milk through a continuous flow, or batch process of pasteurization. System 200 includes a preheating module 208 that preheats raw milk 202, multiple waste heat source modules 206 that release waste heat to the preheating module 208, a waste heat control system 234 that regulates the waste heat, at least one regeneration module 212a, 212b comprising a heat exchange surface 214 that transfers heat between outgoing high temperature pasteurized milk 226 and incoming preheated milk 210, a homogenizing module 216 that homogenizes the heated milk, a heating module 222 that heats the preheated milk 210 to a high temperature pasteurized milk 226, a holding tube 228, at least one feed pump 224a, booster pump 224b, and a culture tank 240 for culturing the cooled pasteurized milk 232 into cultured dairy products.

It is instructive to first look at a standard milk pasteurizing system known in the art. FIG. 1 illustrates a schematic diagram of a prior art milk pasteurization system 100, operational for producing drinking milk and non-cultured dairy products. In this system 100, raw milk 103 enters a balance tank 102, at the temperature at which the raw milk 103 has been stored, about 38° Fahrenheit. From the balance tank 102, raw milk 103 is pumped out by the feed pump into the regeneration means 104 of a heat exchanger. In the regeneration means 104, the raw milk 103 is preheated by pasteurized milk that is coming back on the opposite sides of the heat exchange surfaces at the pasteurization temperature, which is approximately 194.5° Fahrenheit.

The preheated milk 106, which is still below the pasteurization temperature, leaves the regeneration means 104 at and goes through the homogenizer 108. Though other embodiments of the existing technology can include a cream separator and/or a degassing mechanism either after or from an intermediate point in the regeneration means 104. Next, preheated milk 106 enters the heating means 110 and is heated to the pasteurization temperature. After reaching the pasteurization temperature, the milk leaves the heating means 110 and enters the holding tubes 116. After staying in the holding tubes 116 for the required amount of time at the pasteurization temperature, milk leaves the holding tubes 116 and goes through the booster pump 118b.

The necessary heat for the pasteurization heating means 110 is supplied from a water heater 114. An external fuel source heats the water to a temperature above the pasteurization temperature. The hot water enters the heating means 110 on the opposite sides of the heat exchange surfaces from the pre-heated raw milk 103. After giving up some of its heat to the milk, water leaves the heating means 110 and re-enters the water heater to be re-heated.

From the booster pump 118a, 118b, the pasteurized milk re-enters the regeneration means 104, on the opposite sides of the heat exchange surface from the raw milk 103. In the regeneration means 104, the same amount of heat is removed from the pasteurized milk as is added as preheat to the incoming raw milk 103.

This presents a paradox for the existing technology for manufacturing cultured milk products. If the regeneration means 104 is designed to maximize the amount of preheating, then the pasteurized milk 124 gets cooled below the desired culture temperature and therefore needs to be reheated to the culture temperature. If the regeneration means 104 is designed to prevent over-cooling, then the amount of preheating is reduced, adding to the fuel cost for operating the heating means 110.

FIG. 1 further references a reheating means 120 operational near the terminus of the system 100. Pasteurized milk 124 that has already given up part of its heat leaves the regeneration means 104 and enters the reheating means 120. A water tank 112 heats the reheating means 120. After being reheated to the culture temperature, the pasteurized milk leaves the reheating means 120 and enters the culture tank 122. Heat for the reheating means 120 is supplied from a water heater. An external fuel source heats the water to a temperature above the culture temperature. The hot water enters the reheating means 120 on the opposite sides of the heat exchange surfaces from the pasteurized milk. After giving up some of its heat to the pasteurized milk 124, water leaves the reheating means 120 and re-enters the water heater to be re-heated.

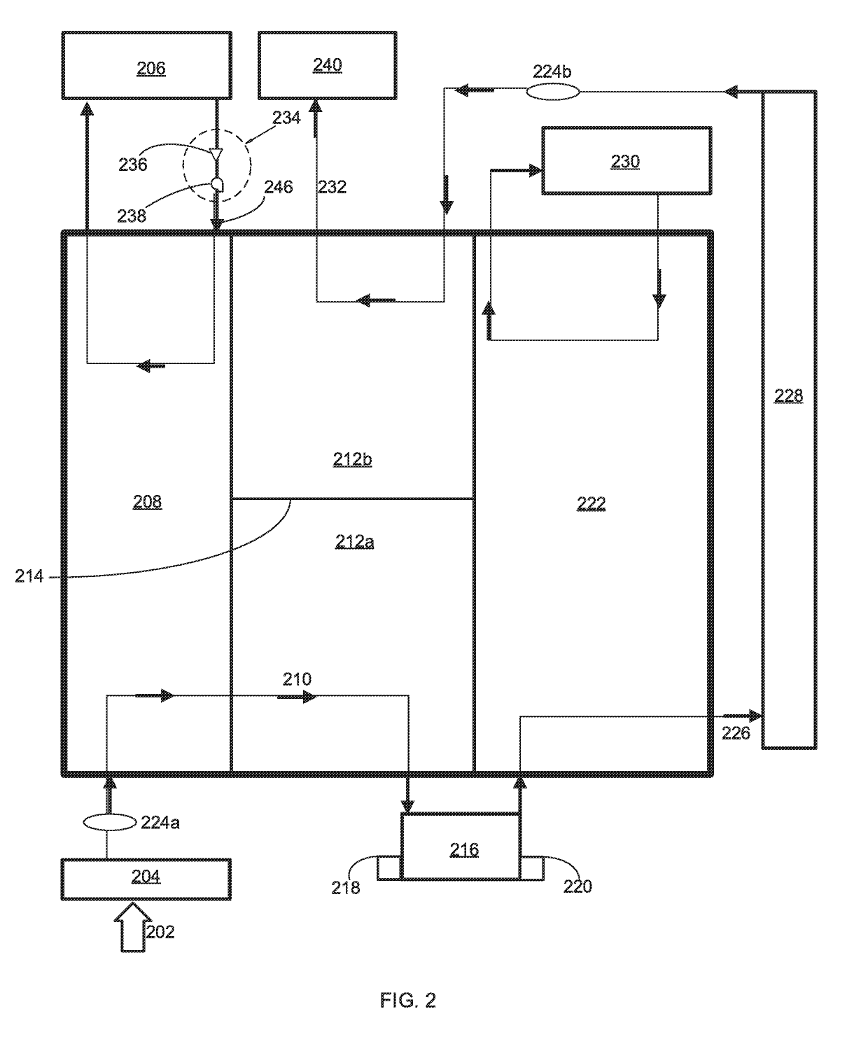

In comparison to the prior art milk pasteurization system 100, FIG. 2 illustrates a schematic diagram of an exemplary system 200 for pasteurizing milk for cultured dairy products. As the diagram of system 200 shows, the raw milk 202 enters the balance tank 204 at about 38° Fahrenheit. At least one feed pump 224a urges raw milk 202 from balance tank 204 to a preheating module 208. Preheating module 208 is operable to preheat the raw milk 202. This preheating means is the first significant difference from the prior art milk pasteurization system 100 discussed above.

In one non-limiting embodiment, preheating module 208 utilizes a warm water supply 246 to at least partially preheat the raw milk 202. In one non-limiting embodiment, warm water supply 246 provides a controlled flow of warm water that perpetually runs during operation of system 200. Warm water supply 246 may include a boiler, electrical water heater, or other external heat source that generates steam for heating the raw milk 202.

Additionally, multiple waste heat source modules 206 work to preheat the raw milk 202. Waste heat source modules 206 release waste heat to the raw milk 202 that is flowing through the preheating module 208. By utilizing waste heat, the amount of steam needed to heat milk in the heating section is reduced and steam use for a reheating section after the regeneration section is reduced or eliminated. System 200 is unique in that heat is added to the incoming raw milk 202 from the source of waste heat, as discussed above. By adding the heat to the incoming raw milk 202, which is approximately 38° Fahrenheit, a lower temperature source of heat can be utilized.

This reduces the need for steam from the water heater or other external heat source to pasteurize milk for production into cultured dairy products, such as yogurt, sour cream, buttermilk, cottage cheese, and other kinds of cheese. In some embodiments, waste heat source modules 206 that release waste heat to preheating module 208 may include, without limitation, a refrigeration desuperheater, a boiler stack, an air compressor cooling system, product cooling, and a refrigeration condenser emitting heat and the like.

The waste heat is harnessed in this manner to reduce the amount of energy required by the preheating module 208 to preheat the raw milk 202. In one non-limiting embodiment, system 200 further comprises a waste heat control system 234 that regulates the waste heat from waste heat source modules 206. In one embodiment, waste heat control system 234 serves to regulate heat release/dissipation from the water heater and waste heat source modules 206. In some embodiments, waste heat control system 234 may include, without limitation, a control valve 236 and a variable speed pump 238.

By use of a control valve 236, a variable speed pump 238, or a combination of the two in the waste heat control system 234 to the preheating module 208, and the amount of waste heat added in the preheating module 208 can be controlled. In this manner, the raw milk 202 flows out of preheating module 208 heated at a higher temperature that prevents the milk from over cooling in a regeneration module 212a, 212b, discussed below.

Next, the preheated milk 210 passes through the regeneration module 212a. Regeneration module 212a comprises a heat exchange system that is configured to allow the preheated milk 210 and high temperature pasteurized milk 226 to flow in opposite directions on opposite sides of a heat exchange surface 214. Preheated milk 210 entering regeneration module 212a absorbs heat from the high temperature pasteurized milk 226 flowing in an opposite direction through regeneration module 212a. This adds heat to preheated milk 210.

Specifically, preheated milk 210 passing through regeneration module 212a gains additional heat from the high temperature pasteurized milk 226 that flows back on the opposite sides of heat exchange surface 214 at the pasteurization temperature, which is approximately 194.5° Fahrenheit. Consequently, the amount of heating required to heat the preheated milk 210 to a pasteurization temperature in a subsequent heating module is reduced. This serves to conserve further energy.

In one embodiment, heat exchange surface 214 comprises a plate and frame heat exchanger that enables efficient transfer of heat from the outgoing, high temperature pasteurized milk 226 to the incoming preheated milk 210. Those skilled in the art will recognize that the same amount of heat that is added to the preheated milk 210 in the regeneration module 212a is taken out of the high temperature pasteurized milk 226. This provides the same amount of “free cooling” as “free heating.” This is the ideal situation for milk that is to be bottled, since the desired final cooling temperature of about 38° Fahrenheit is about equal to the incoming raw milk temperature.

However, for milk that is to be pasteurized for production of cultured dairy products, the need for heating exceeds the need for cooling; and thereby, the heating and cooling needs across heat exchange surface 214 of the regeneration module 212a do not balance. The pasteurized milk needs to be cooled only to the desired temperature for culturing, usually in the 86° F. to 113° F. (30° C. to 45° C.,) range, depending on the dairy product being made and the culture bacteria used.

Regeneration module 212a, 212b can be designed to add a fixed amount of heat from pasteurized milk to raw milk 202 that has either a low input and low output temperature or a higher input and higher output temperature. The amount of heat needed at the heating section is minimized by maximizing the output temperature from the regeneration section. An infinitely large regeneration section would be 100% efficient and require no additional heat input to the heating section. Lower temperature inputs and outputs would reduce the capital cost of the regeneration section and could utilize lower temperature waste heat.

The “approach” temperature for the regeneration section can be specified and this will determine all other temperatures. The approach temperature would be the difference between the culture temperature and the temperature of the incoming raw milk from the pre-heating section. The lower the approach temperature, the lower will be the heat needed at the heating section. The input temperature of raw milk coming from the pre-heating section into the regeneration section is therefore the culture temperature minus the approach temperature, the same as the input temperature of raw milk to regeneration module 212a, 212b. The water that has been heated from waste heat in the plant must be above this temperature. The water must be at least as hot as the desired output temperature of the raw milk plus the approach temperature specification of the pre-heating section.

In one alternative embodiment, an initial preheating module 208 operable to preheat the raw milk 202 with waste heat prior to entering the regeneration module 212a. System 200 also includes a second regeneration module 212b operable to receive the high temperature pasteurized milk 226 for releasing additional heat to the preheated milk 210. Though in other embodiments, only one regeneration module is used. In any case, system 200 does not bring cultured dairy products back to the same heat exchanger that is used for heat treating the milk prior to culturing.

In other embodiments, system 200 comprises a homogenizing module 216 that receives the heated raw milk from regeneration module 212a. Though in other embodiments, Homogenizing module 216 may be integrated into regeneration module 212a. Those skilled in the art will recognize that the homogenization of milk is a mechanical process that breaks the fat globules into smaller droplets so that they stay suspended in the milk rather than separating out and floating to the top of the milk container.

It is also known that homogenization is accompanied with pasteurization in modern milk production facilities. In yet another embodiment, the system comprises a cream separator 218, or a degasser 220, or both receiving heated milk from the regeneration module 212a. The cream separator 218 and degasser 220 may replace the homogenizing module 216, or work in conjunction.

The heated milk next flows through a heating module 222 that heats the milk up to a pasteurization temperature of about 188° Fahrenheit. This high temperature serves to kill unwanted bacteria in the raw milk 202, and cause proteins in the milk to be denatured to facilitate the manufacture of cultured products. In one non-limiting embodiment, heat for heating module 222 is supplied by a water heater 230. Further, an external fuel source may heat water heater 230 to a temperature above the pasteurization temperature. The hot water from water heater 230 enters heating module 222 on the opposite sides of heat exchange surface 214 from the preheated milk 210. After giving up some of its heat to the heated milk, the water leaves heating module 222 and re-enters the water heater to be re-heated.

The now extremely hot, pasteurized milk flows into a holding tube 228 for a predetermined duration. Holding tube 228 is sized and dimensioned to provide a fixed volume of tubing to hold the high temperature pasteurized milk 226 for a set period of time at a given flow rate. Those skilled in the art will recognize that a holding tube is required for processes, like pasteurization, sterilization, thermal deactivation, or protein denaturing, that require a dwell time at a given temperature. In one non-limiting embodiment, holding tube 228 may slope upwards ¼″/ft. in direction of flow to eliminate air entrapment so nothing flows faster at air pocket restrictions. Though any number of configurations for holding tube 228 may be used.

After high temperature pasteurized milk 226 leaves holding tube 228, it passes through at least one booster pump 224b that increases the pressure of the pasteurized milk 226. Booster pump 224b forces the high temperature pasteurized milk 226 a second time through at least one of the regeneration modules 212a-b; in an opposite direction from the incoming preheated milk 210.

In some embodiments, regeneration module 212b may be different and separate from regeneration module 212a, in which preheated raw milk 202 enters for further heating. Thus, high temperature pasteurized milk 226 enters regeneration module 212b, on the opposite sides of the heat exchange surface 214 from regeneration module 212a that receives the incoming preheated milk 210. This helps to achieve heat transfer to the preheated milk 210. In this manner, the same amount of heat is removed from the high temperature pasteurized milk 226 as is added to the preheated milk 210. This serves the objective of urging the cooled pasteurized milk 232 out of the regeneration module 212b and into the culture tank 240 at the desired culture temperature, rather than using a reheating means prior to entering the culture tank 240.

As discussed above, this serves the dual purpose of further heating the preheated milk 210, and lowering the temperature of the pasteurized milk 232 to achieve the desired culture temperature for cultured dairy products. And thus, an objective is achieved of providing only the amount of cooling in the regeneration module 212b that is needed to bring the temperature of pasteurized milk 232 down from the pasteurization temperature to the culture temperature.

This causes the pasteurized milk 232 to cool down to a culture temperature of about 86° Fahrenheit, which is higher than the standard pasteurized temperature, and also an appropriate temperature for culturing dairy products. This is because the culture bacteria used to convert milk to cultured dairy products grows best in higher temperatures, i.e. 86° Fahrenheit. The cooled pasteurized milk next flows into a culture tank 240 for further culturing and storage. After the culture period is completed, the cheese, buttermilk, yogurt, or other cultured dairy product may be cooled in a separate heat exchanger, which could be a conventional heat exchanger.

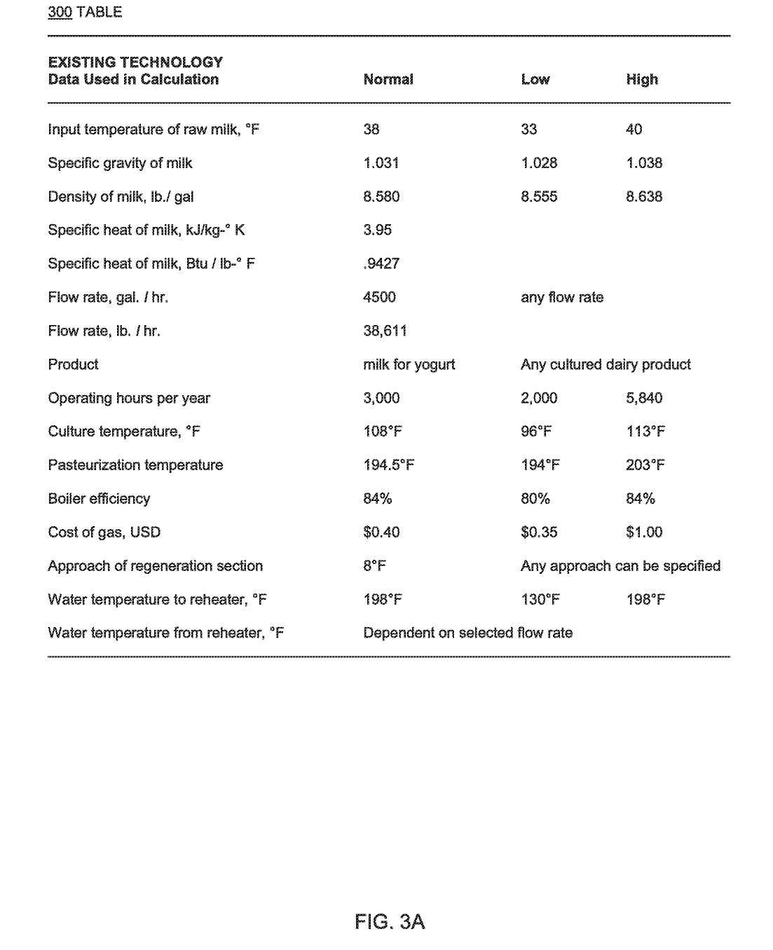

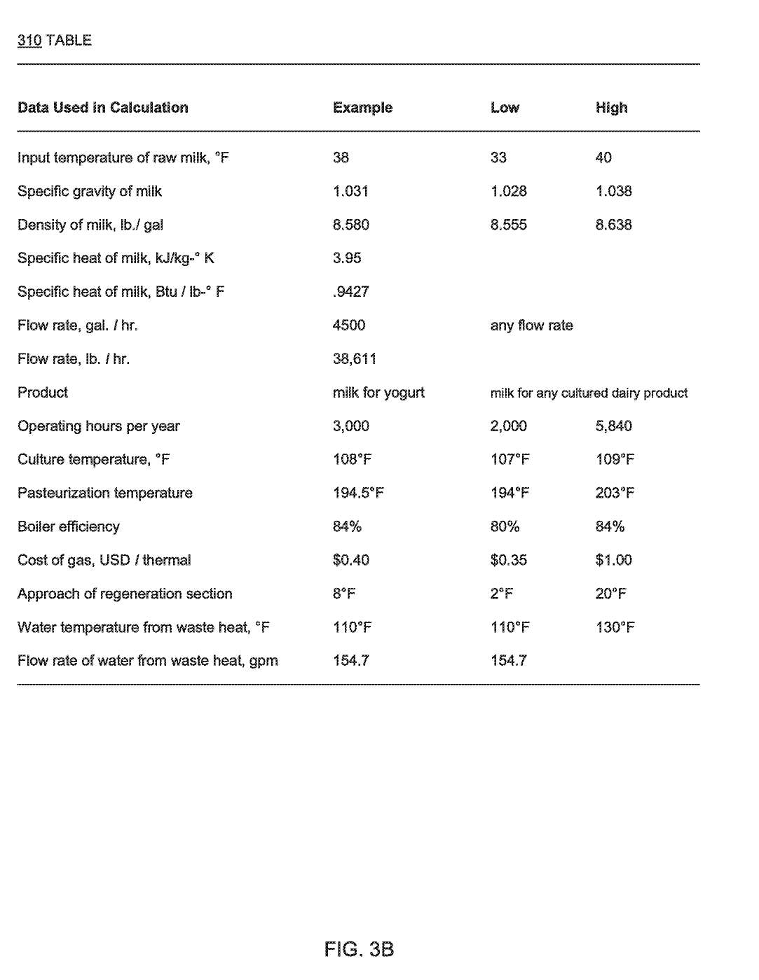

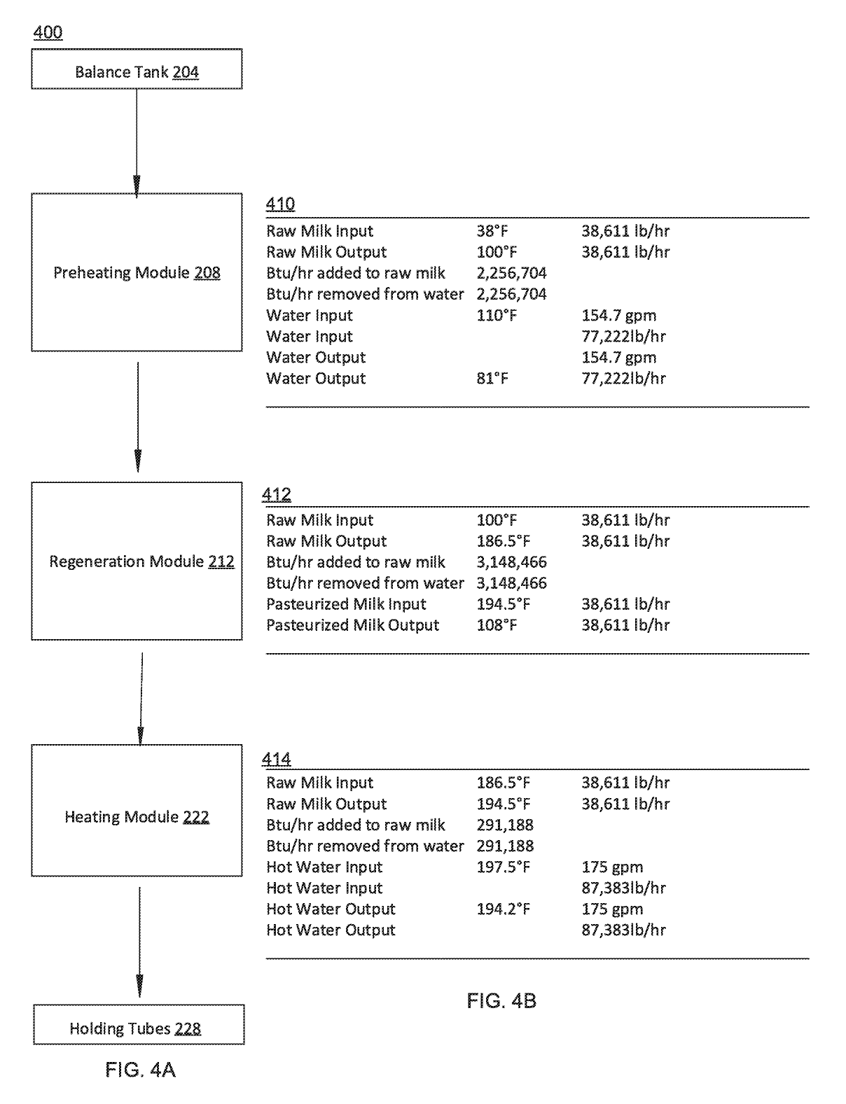

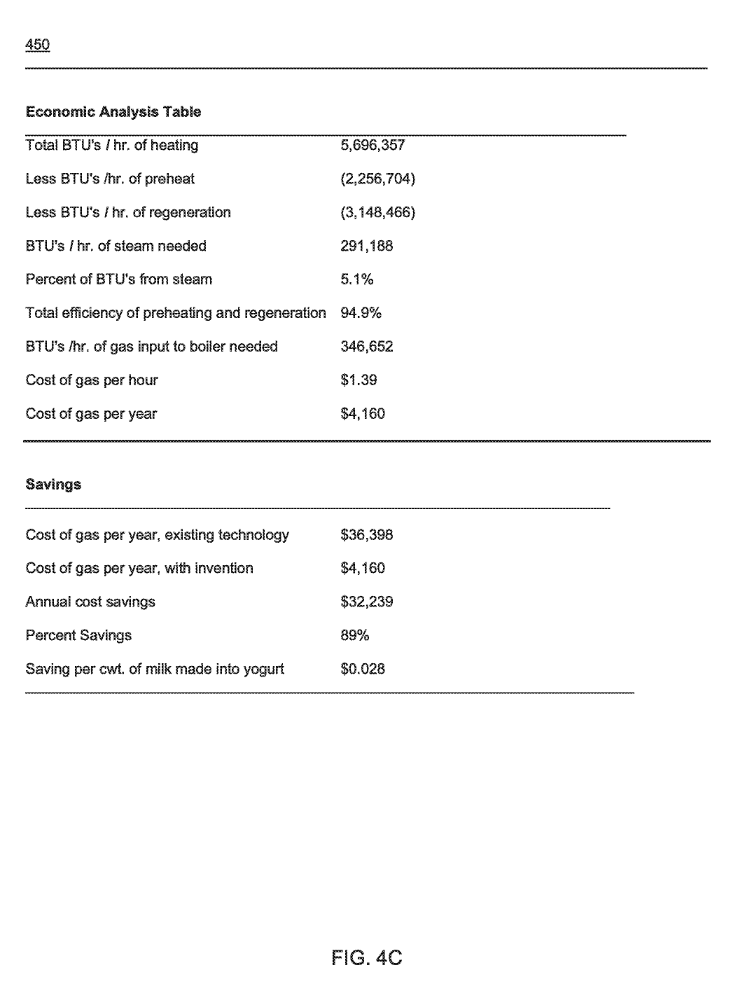

FIG. 3A shows data for the milk and heating water used in the prior art milk pasteurization system 100. FIG. 3B shows data for the system 200 for pasteurizing milk for cultured dairy products. The differences are primarily in the amount of BTU of heat required to heat the milk. The differences illustrated on FIG. 4C shows that the novel milk pasteurization system 200 conserves energy, chiefly through preheating of raw milk 202, and use of waste heat, which negates the need to reheat the cooled pasteurized milk 232 for preparation of cultured dairy products. This is because the temperature of preheated milk 210 coming out of the preheating module 208 is just warm enough to prevent over-cooling in regeneration module 212b. Heated milk coming out of the regeneration module 212b is thus, at the temperature needed for the culture bacteria to grow. Consequently, the need to reheat pasteurized milk to the culture temperature or the need for some of the hot pasteurized milk to bypass the regeneration section to prevent over cooling is eliminated.

The prior art milk pasteurization system 100 requires reheating to achieve the appropriate temperature for cultured dairy products, which consumes large amounts of energy. As referenced in Table 300, the data points for operation of the system 100 show that the raw milk 202 enters system 100 at 38° Fahrenheit, and achieves a culture temperature of 108° Fahrenheit and a pasteurization temperature of 194.5° Fahrenheit. The reheating means required for the prior art system 100 is about 130° to 198° Fahrenheit. This high temperature requires great amounts of energy to achieve.

The intermediate calculations for heating the milk for pasteurization of cultured dairy products show that the specific heat of milk is calculated as: 3.95 J/kg-° K.×5° K./9° F.×1 BTU/1.00587 kJ×1 kg/2.22046 lbs.=0.9427 BTU/lb.-° Fahrenheit. Next, the ΔT from raw milk input temperature to pasteurization temperature is calculated as: 194.5° Fahrenheit−38° Fahrenheit=156.5° Fahrenheit. This allows for the total BTU's/hour needed for heating from raw milk input temperature to pasteurization temperature as: 38,611 lbs.×156.5° F.ΔT×0.9427 S.H.=5,696,357.

Turning now to Table 310, shown in FIG. 3B, the data points for operation of the system 100 show that the raw milk 202 enters system 200 at 38° Fahrenheit, and achieves a culture temperature of 108° Fahrenheit and a pasteurization temperature of 194.5° Fahrenheit. The reheating means required for the prior art system 100 is not necessary for system 200, since the raw milk 202 is preheated with waste heat. The heat used for preheating the raw milk 202 is waste heat having a temperature of about 110° Fahrenheit. This 110° Fahrenheit temperature is significantly less than the 130° to 198° Fahrenheit temperature used for reheating in the prior art system 100. As a result, energy costs are greatly reduced (See FIG. 4C economic analysis Table 450).

Further, Approach of regeneration, as shown in Table 310 is 8° Fahrenheit as used in the figure for calculating the example. It is known in the art that “Approach” means how close the temperatures come between the incoming of one fluid and the outgoing of the other fluid. A heat exchanger can be designed with any approach. The smaller you make the approach, the more efficient the heat exchanger is, but the higher the capital cost. A compromise is always chosen, most commonly about 10° Fahrenheit.

System 200 uses similar intermediate calculations to determine costs when heating the milk for pasteurization of cultured dairy products. The specific heat of milk is calculated as: 3.95 J/kg-° K.×5° K./9° F.×1 BTU/1.00587 kJ×1 kg/2.22046 lbs.=0.9427 BTU/lb.-° Fahrenheit. Next, the AT from raw milk input temperature to pasteurization temperature is calculated as: 194.5° Fahrenheit−38° Fahrenheit=156.5° Fahrenheit. This allows for the total BTU's/hour needed for heating from raw milk input temperature to pasteurization temperature as: 38,611 lbs.×156.5° F. L\T×0.9427 S.H.=5,696,357.

Turning now to FIG. 4A, a flowchart of a process 400 shows the flow of milk through the various modules at different temperatures, being heated by the warm water supply and waste heat, so as to achieve the resultant pasteurized milk temperatures. Initially, raw milk 202 is introduced into the preheating module 208 at maximum regeneration is shown. It is primarily the preheating that allows the system 200 to have an 89% percent savings in energy costs for pasteurizing the raw milk into cultured dairy products. This is possible because, when the raw milk is introduced at different temperatures, the warm water supply 246 temperature, and the resultant temperatures for the cooled pasteurized milk 232 are affected accordingly.

FIG. 4B references Table 410 showing the accompanying data points in the preheating module 208. Raw milk 202 is introduced at about 38° Fahrenheit at 38,611 lb/hr. Raw milk output is about 100° Fahrenheit at 38,611 lb/hr. The Btu/hr added to the raw milk is 2,256,704. The Btu/hr removed from the water is about 2,256,704. As can be seen in the flowchart, raw milk 202 is introduced in balance tank 204 before being preheated in preheating module 208 with waste heat. For heating the milk in the preheating module 208, the water input is at 110° Fahrenheit. The water output after releasing heat to the milk in the preheating module 208 is about 81° Fahrenheit.

Preheated milk 210 then passes through regeneration module 212a, where heat transfer occurs with outgoing high temperature pasteurized milk 226. As Table 412 in FIG. 4B references, raw milk input temperature in regeneration module 212a is about 100° Fahrenheit. Raw milk output temperature leaving regeneration module 212a is about 186.5° Fahrenheit, as the raw milk is heated by the outgoing high temperature pasteurized milk 226. The pasteurized milk output is 108° Fahrenheit after releasing heat to the incoming preheated milk 210.

Process 400 next shows raw milk entering heating module 222, which further heats milk to reach the pasteurized temperature of about 194.5° Fahrenheit, ideal for cultured dairy products. As Table 414 in FIG. 4B references, raw milk input temperature in heating module 222 is about 186.5° Fahrenheit. Raw milk output temperature leaving heating module 222 is about 194.5° Fahrenheit, as the raw milk is heated while flowing at 38,611 lb/hr. To achieve this high temperature, how water input from the water heater 230 is about 197.5° Fahrenheit at a flow rate of 175 gpm. The hot water returns to water heater at a cooler 194.2° Fahrenheit after releasing heat to the milk. Process 400 also shows that holding tube 228 holds and delivers high temperature pasteurized milk 226 to regeneration module 212b, where heat is lost to incoming preheated milk. These data points demonstrate a clear correlation between heating the raw milk 202 and the resultant temperature of the cooled pasteurized milk 232, which saves energy and costs for the pasteurization plant.

FIG. 4C references an Economic Analysis Table 450 showing the economic benefits of milk pasteurization system 200 compared to the prior art pasteurization system 100. As discussed above, by preheating the raw milk 202 with waste heat, the amount of heat required to reheat the pasteurized milk leaving regeneration unit 212b is eliminated; thereby conserving energy.

As Table 450 shows, one benefit can include a reduction of 2,256,704 BTU's/hr. for preheating raw milk 202 rather than reheating. Also, the waste heat used for preheating conserves energy since it is not generated specifically for heating milk, but rather a byproduct of boilers, and dissipated heat from other components. In addition to the 2,226,704 BTU/hr. input from waste heat, an additional 3,148,466 BTU/hr. of heat is recovered in the regeneration section. The total BTU of free heat is therefore 5,375,170 BTU of the 5,696,357 BTU required for pasteurization, or 94.9%.The waste heat results in about 3,148,466 less BTU's of heat during the regeneration of the pasteurized milk. These economic benefit calculations show BTU's/hr. of steam needed 291,188; at a percentage of BTU's from steam 5.1%. As a result, system 200 has a total efficiency of preheating and regeneration of about 94.9%, even with 346,652 BTU's/hr. of gas input to boiler required.

In economic savings, i.e., dollars, the prior art system 100 requires gas for pasteurizing and reheating at a cost of $36,398 per year. The milk pasteurization system 200, which conserves energy through preheating and use of waste heat, has a lower cost of about $4,160 per year for gas. This results in an annual cost savings of $32,239, or an 89% percent savings in energy costs. In terms of cwt. of milk made into the cultured dairy product, i.e., yogurt, the savings are about $0.028 (FIG. 4C).

Although the original intent of system 200 was to eliminate the cost of re-heating milk that had been over-cooled in the regeneration section, the calculations show that there is also a large saving in the heating section. With warmer milk coming into the regeneration section, the output from the regeneration section is also warmer. This reduces the number of degrees that the milk needs to be raised in the heating section. For milk that is to be bottled, heat exchanger manufacturers are now offering regeneration sections that are 94% to 95% efficient.

Existing technology for cultured milk products, however, has much lower efficiency because of the imbalance between heating needs and cooling needs. In the example presented for existing technology, the regeneration section is only 65.8% efficient. With existing milk pasteurization technology, there is less benefit in purchasing a more efficient regeneration section. Any savings of heat at the heating section would only result in a corresponding increase in heat needed at the re-heating section.

Thus, system 200 makes it possible for the efficiency of heat treating milk for cultured products to be just as high as the efficiency of pasteurizing milk for bottling. Dairy plants will have the choice of including a more efficient regeneration section in the re-engineering of the heat exchanger or merely replacing the re-heating section with a pre-heating section. Even with an existing, less efficient regeneration section, fuel savings can be approximately 71%. Thus, milk pasteurization system 200 provides the economic advantages of lower costs for pasteurizing milk for cultured dairy products.

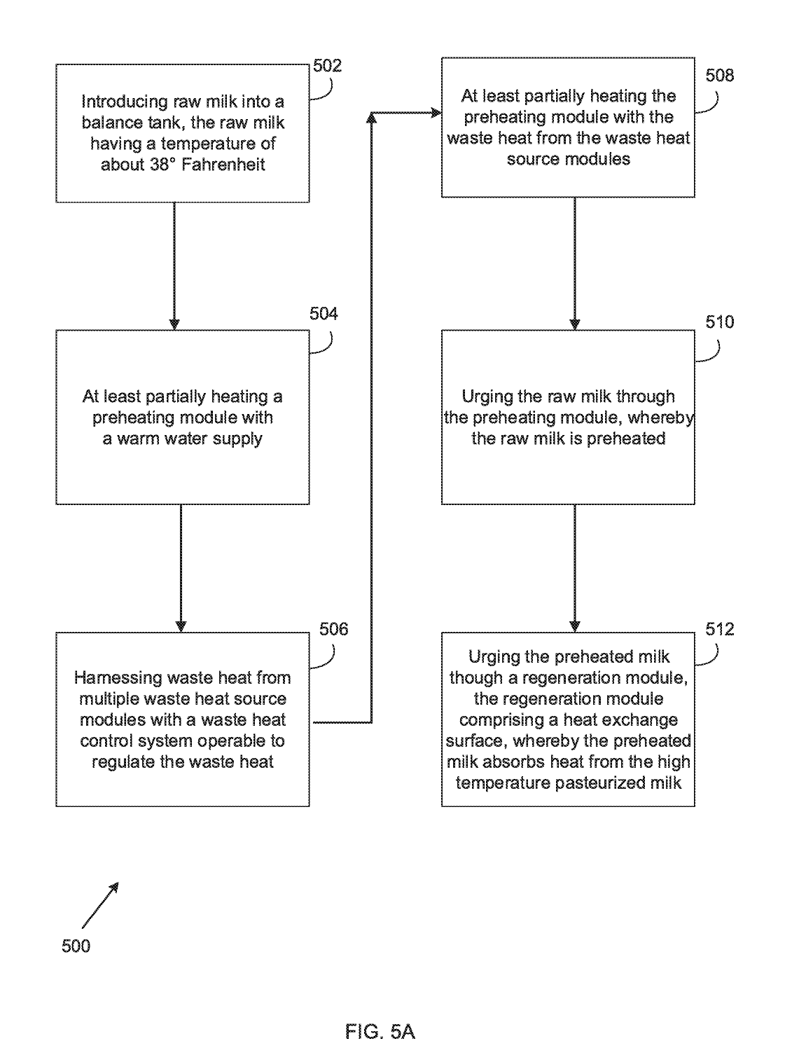

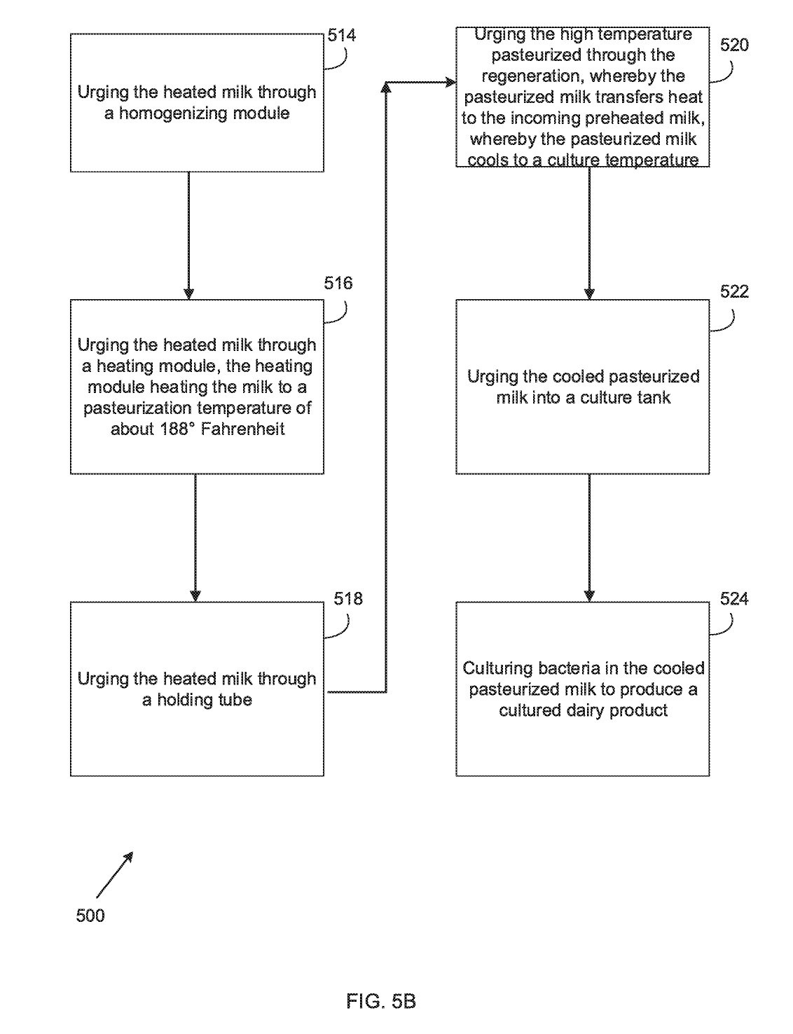

FIGS. 5A and 5B illustrate flowcharts of an exemplary method 500 for pasteurizing milk for cultured dairy products. The method 500 is configured to urge raw milk 202 through a continuous flow pasteurization process, or a batch process, that heats the milk up to a cultured temperature. The milk passes through a series of modules that sequentially heat the raw milk to a culture temperature that is efficacious for culturing dairy products, such as yogurt, cheese, sour cream, and buttermilk. Quite uniquely, the modules work to heat up the milk, cool down the milk, transfer heat between preheated milk 210 and high temperature pasteurized milk 226, and homogenize the milk, while also reducing the amount of energy required to pasteurize the milk.

The method may include an initial Step 502 of introducing raw milk into a balance tank, the raw milk having a temperature of about 38° Fahrenheit. The method 500 may further comprise a Step 504 of at least partially heating a preheating module with a warm water supply 246. Preheating module 208 is operable to preheat the raw milk 202. A Step 506 includes harnessing waste heat from multiple waste heat source modules with a waste heat control system operable to regulate the waste heat.

In some embodiments, a Step 508 comprises at least partially heating the preheating module with the waste heat from the waste heat source modules. In one embodiment, waste heat control system 234 serves to regulate heat release/dissipation from the water heater and waste heat source modules 206. In some embodiments, waste heat control system 234 may include, without limitation, a control valve 236 and a variable speed pump 238. By use of a control valve 236, a variable speed pump 238, or a combination of the two in the waste heat control system 234 to the preheating module 208, and the amount of waste heat added in the preheating module 208 can be controlled.

In some embodiments, a Step 510 includes urging the raw milk through the preheating module, whereby the raw milk is preheated. A Step 512 may include urging the preheated milk though a regeneration module, the regeneration module comprising a heat exchange surface, whereby the preheated milk and a high temperature pasteurized milk flow in opposite directions on opposite sides of the heat exchange surface, whereby the preheated milk absorbs heat from the high temperature pasteurized milk. A Step 514 comprises urging the heated milk through a homogenizing module.

Another Step 516 may include urging the heated milk through a heating module, the heating module heating the milk to a pasteurization temperature of about 194.5° Fahrenheit. The heated milk next flows through a heating module 222 that heats the milk up to a pasteurization temperature of about 194.5° Fahrenheit. This high temperature serves to kill unwanted bacteria in the raw milk 202, and cause proteins in the milk to be denatured to facilitate the manufacture of cultured products. In one non-limiting embodiment, heat for heating module 222 is supplied by a water heater 230. A Step 518 includes urging the heated milk through a holding tube.

A Step 520 includes urging the high temperature pasteurized through the regeneration module with a booster pump, whereby the high temperature pasteurized milk transfers heat to the incoming preheated milk, whereby the pasteurized milk cools to a culture temperature of about 86° Fahrenheit. A Step 522 includes urging the cooled pasteurized milk into a culture tank. A final Step 524 includes culturing bacteria in the cooled pasteurized milk to produce a cultured dairy product. After the culture period is completed, the cheese, buttermilk, yogurt, or other cultured dairy product may be cooled in a separate heat exchanger.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An energy efficient method for pasteurizing milk for cultured dairy products, the method comprising:
introducing raw milk into a balance tank;
at least partially heating a preheating module with a warm water supply;
harnessing waste heat from at least one waste heat source module;
at least partially heating the preheating module with the waste heat from the at least one waste heat source module;
urging the raw milk through the preheating module, whereby the raw milk is preheated;
urging the preheated milk though at least one regeneration module, the regeneration module comprising a heat exchange surface, whereby the preheated milk and a high temperature pasteurized milk flow in opposite directions on opposite sides of the heat exchange surface, whereby the preheated milk absorbs heat from the high temperature pasteurized milk;
urging the heated milk through a heating module, the heating module heating the milk to a pasteurization temperature;
urging the high temperature pasteurized milk through the regeneration module, whereby the high temperature pasteurized milk transfers heat to the incoming preheated milk, whereby the pasteurized milk cools to a culture temperature; and
urging the cooled pasteurized milk into a culture tank.

2. The method of claim 1, wherein the incoming raw milk has a temperature of about 38° Fahrenheit.

3. The method of claim 1, wherein the pasteurization temperature is about 188° Fahrenheit.

4. The method of claim 1, wherein the culture temperature is about 86° Fahrenheit.

5. The method of claim 1, wherein the step of harnessing waste heat from at least one waste heat source module comprises a waste heat control system operable to regulate the waste heat.

6. The method of claim 5, wherein the waste heat control system comprises a control valve and/or a variable speed pump.

7. The method of claim 1, further comprising a step of urging the preheated milk through a homogenizing module, after passing through the regeneration module.

8. The method of claim 1, further comprising a step of urging the preheated milk through a cream separator, or a degasser, or both, after passing through the regeneration module.

9. The method of claim 1, further comprising a step of urging the heated milk through a holding tube, after passing through the heating module.

10. The method of claim 1, further comprising a step of urging the heated milk through at least one booster pump, after passing through the holding tube.

11. The method of claim 1, further comprising a step of urging the raw milk through an initial regeneration module operable to preheat the raw milk with waste heat prior to entering the regeneration module.

12. The method of claim 1, further comprising a step of culturing bacteria in the cooled pasteurized milk to produce a cultured dairy product.

13. The method of claim 1, wherein the cultured dairy product includes at least one of the following: yogurt, cheese, sour cream, and buttermilk.

14. An energy efficient method for pasteurizing milk for cultured dairy products, the method consisting of:
introducing raw milk into a balance tank, the raw milk having a temperature of about 38° Fahrenheit;
at least partially heating a preheating module with a warm water supply;
harnessing waste heat from at least one waste heat source module with a waste heat control system operable to regulate the waste heat;
at least partially heating the preheating module with the waste heat from the at least one waste heat source module;
urging the raw milk through the preheating module, whereby the raw milk is preheated;
urging the preheated milk though at least one regeneration module, the regeneration module comprising a heat exchange surface, whereby the preheated milk and a high temperature pasteurized milk flow in opposite directions on opposite sides of the heat exchange surface, whereby the preheated milk absorbs heat from the high temperature pasteurized milk;
urging the heated milk through a homogenizing module;
urging the heated milk through a heating module, the heating module heating the milk to a pasteurization temperature of about 188° Fahrenheit;
urging the heated milk through a holding tube;
urging the heated milk through at least one booster pump;
urging the high temperature pasteurized milk through the regeneration module, whereby the high temperature pasteurized milk transfers heat to the incoming preheated milk, whereby the pasteurized milk cools to a culture temperature of about 86° Fahrenheit;
urging the cooled pasteurized milk into a culture tank; and
culturing bacteria in the cooled pasteurized milk to produce a cultured dairy product.

15. The method of claim 14, wherein the waste heat control system comprises a control valve and/or a variable speed pump.

16. The method of claim 14, further comprising a step of urging the preheated milk through a cream separator, or a degasser, or both, after passing through the regeneration module.

17. The method of claim 14, further comprising a step of urging the raw milk through an initial preheating module operable to preheat the raw milk with waste heat prior to entering the regeneration module.

18. An energy efficient system for pasteurizing milk for cultured dairy products, the system comprising:
a balance tank containing raw milk, the raw milk having a temperature of about 38° Fahrenheit;
a water heater releasing heat;
at least one waste heat source module releasing waste heat;
a waste heat control system regulating the release of the waste heat;
at least one regeneration module comprising a heat exchange surface, whereby the preheated milk and a high temperature pasteurized milk flow in opposite directions on opposite sides of the heat exchange surface, whereby the preheated milk absorbs heat from the high temperature pasteurized milk;
a homogenizing module receiving the heated milk from the regeneration module;
a heating module receiving the heated milk from the homogenizing module, the heating module heating the milk to a pasteurization temperature of about 188° Fahrenheit;
a holding tube receiving the pasteurized milk from the heating module;
at least one booster pump urging the high temperature pasteurized milk through the regeneration module, whereby the high temperature pasteurized milk transfers heat to the incoming preheated milk, whereby the pasteurized milk cools to a culture temperature of about 86° Fahrenheit; and
a culture tank receiving the cooled pasteurized milk.

19. The method of claim 18, wherein the waste heat control system comprises a control valve and a variable speed pump.

20. The method of claim 18, wherein the culture tank cultures bacteria for producing cultured dairy products.
